(19) United States
(12) Patent Application Publication
(10) Pub. No.: US 2024/0404757 A1
(43) Pub. Date: Dec. 5, 2024

(54) MULTILAYER CERAMIC CAPACITOR

(71) Applicant: Murata Manufacturing Co., Ltd., Nagaokakyo-shi (JP)

(72) Inventor: Takashi YOSHINO, Nagaokakyo-shi (JP)

(21) Appl. No.: 18/805,976

(22) Filed: Aug. 15, 2024

Related U.S. Application Data
(63) Continuation of application No. PCT/JP2023/015131, filed on Apr. 14, 2023.

(30) Foreign Application Priority Data
Jun. 17, 2022 (JP) 2022-097764

(51) Int. Cl. H01G 4/258; H01G 4/008; H01G 4/012; H01G 4/12; H01G 4/232; H01G 4/30

(52) U.S. Cl. CPC H01G 4/258; H01G 4/008; H01G 4/012; H01G 4/1227; H01G 4/232; H01G 4/30

(57) ABSTRACT

A multilayer ceramic capacitor includes a multilayer body including laminated dielectric layers, first and second main surfaces, first and second lateral surfaces, first and second end surfaces, first and second internal electrode layers laminated alternately with the dielectric layers and respectively exposed at the first and second end surfaces, first and second external electrodes respectively connected to the first and second internal electrode layers. The dielectric layers include a ceramic material. The ceramic material includes ceramic particles with an average particle diameter of about 710 nm or greater and about 830 nm or less. A percent coverage of the dielectric layers by the first internal electrode layers and a percent coverage of the dielectric layers by the second internal electrode layers are about 60% or higher and about 85% or lower.

### CROSS REFERENCE TO RELATED APPLICATIONS

This application claims the benefit of priority to Japanese Patent Application No. 2022-097764 filed on Jun. 17, 2022 and is a Continuation of PCT Application No. PCT/JP2023/015131 filed on Apr. 14, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

It is preferable that the rate of change in capacitance of a multilayer ceramic capacitor is maintained low over a wide temperature range, and such characteristics are referred to as capacitance-temperature characteristics. In order to achieve good capacitance-temperature characteristics, Japanese Unexamined Patent Application, Publication No. 2010-37112 focuses on the composition of a ceramic material of a dielectric, and discloses ensuring large absolute values of capacitance-temperature characteristics over a wide temperature range by using a dielectric ceramic composition including a main component represented by a general formula (Ba_{1-x-y}SrₓCa_{y})ₘ(Ti_{1-z}Zr_{z})O₃ instead of any of traditionally used material compositions.

The foregoing conventional technology has disadvantages described below. The capacitance-temperature characteristics of a multilayer ceramic capacitor are related to the temperature rise of the multilayer ceramic capacitor, and there are various causes for the temperature rise. However, the technology disclosed in Japanese Unexamined Patent Application, Publication No. 2010-37112 does not take into account causes of heat generation, especially self-heating that occurs when a high-frequency electric current is handled (referred to below as “high-frequency heat generation”).

### SUMMARY OF THE INVENTION

Example embodiments of the present invention provide multilayer ceramic capacitors that each enable a reduction in high-frequency heat generation and achieves improved long-term reliability.

A multilayer ceramic capacitor according to an example embodiment of the present invention includes a multilayer body including a plurality of laminated dielectric layers, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction, first internal electrode layers alternately laminated with the plurality of dielectric layers and exposed at the first end surface, second internal electrode layers alternately laminated with the plurality of dielectric layers and exposed at the second end surface, a first external electrode connected to the first internal electrode layers and provided on the first end surface, and a second external electrode connected to the second internal electrode layers and provided on the second end surface. The dielectric layers include a ceramic material. The ceramic material includes ceramic particles with an average particle diameter of about 710 nm or greater and about 830 nm or less. A percent coverage of the dielectric layers by the first internal electrode layers and a percent coverage of the dielectric layers by the second internal electrode layers are about 60% or higher and about 85% or lower.

Due to the configuration in which the average particle diameter of the ceramic particles in the ceramic material included in the dielectric layers is about 710 nm or greater and about 830 nm or less, and the percent coverage of the dielectric layers by the first internal electrode layers and the percent coverage of the dielectric layers by the second internal electrode layers are about 60% or higher and about 85% or lower, the grain boundary ratio and the number of particles in the dielectric layers are appropriately adjusted, and the dielectric layers are prevented from having unfavorable heat generation characteristics.

Thus, the multilayer ceramic capacitors according to example embodiments of the present invention each reduce or prevent high-frequency heat generation and achieve improved long-term reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of an example of a multilayer ceramic capacitor according to an example embodiment of the present invention.

FIG. 2 is a cross-sectional view taken along line II-II in FIG. 1.

FIG. 3 is a cross-sectional view taken along line III-III in FIG. 1.

FIG. 4 is a plan view corresponding to a cross-section taken along line IV-IV in FIG. 2 and shows a configuration of internal electrode layers of a multilayer ceramic capacitor according to an example embodiment of the present invention.

FIGS. 5A and 5B are each a schematic cross-sectional view based on an image captured using a metallographic microscope showing an LT plane of a multilayer ceramic capacitor for illustrating a percent coverage calculation method.

FIG. 6A is a schematic diagram corresponding to the cross-sectional view taken along line II-II in FIG. 1 and schematically shows a structure in which a counter electrode portion of each internal electrode layer of a multilayer ceramic capacitor according to an example embodiment of the present invention is divided into two portions.

FIG. 6B is a schematic diagram corresponding to the cross-sectional view taken along line II-II in FIG. 1 and schematically shows a structure in which a counter electrode portion of each internal electrode layer of a multilayer ceramic capacitor according to an example embodiment of the present invention is divided into three portions.

FIG. 6C is a schematic diagram corresponding to the cross-sectional view taken along line II-II in FIG. 1 and schematically shows a structure in which a counter electrode portion of each internal electrode layer of a multilayer ceramic capacitor according to an example embodiment of the present invention is divided into four portions.

FIG. 7 is a diagram showing a graph representing heat generation characteristics of a multilayer ceramic capacitor according to an example embodiment of the present invention.

### DETAILED DESCRIPTION OF THE EXAMPLE EMBODIMENTS

Example embodiments of the present invention will be described in detail below with reference to the drawings.

### 1. Multilayer Ceramic Capacitor

The following describes a multilayer ceramic capacitor 10 according to an example embodiment of the present invention.

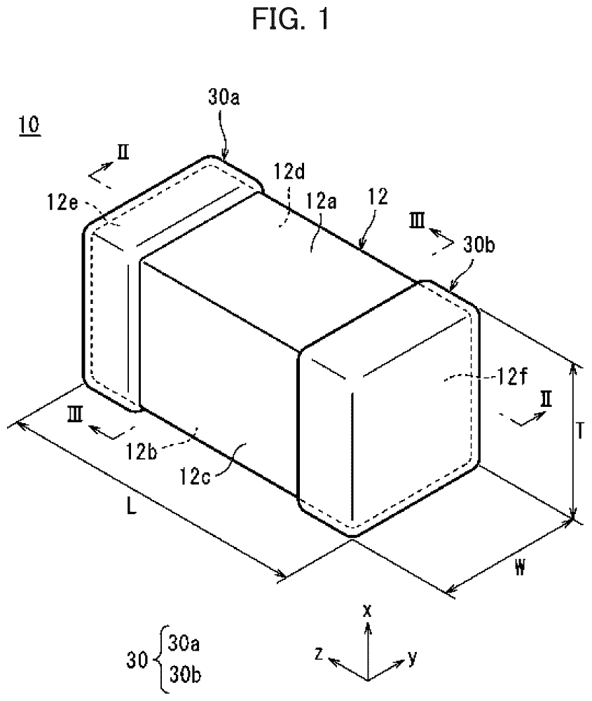

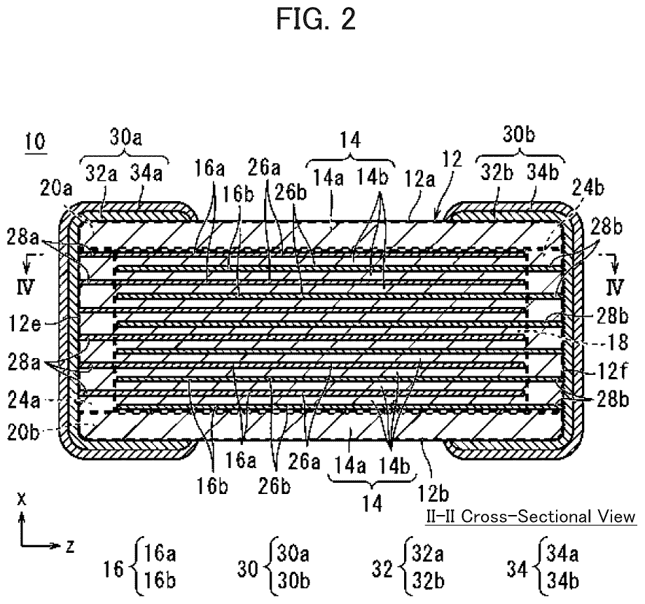

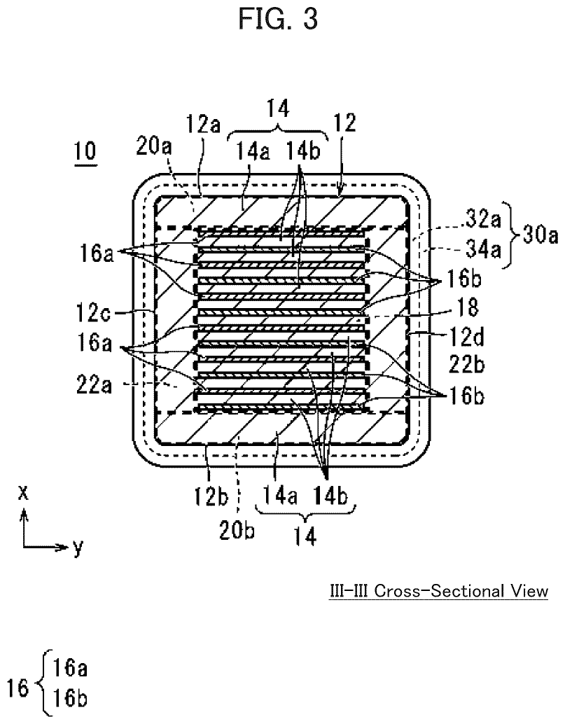

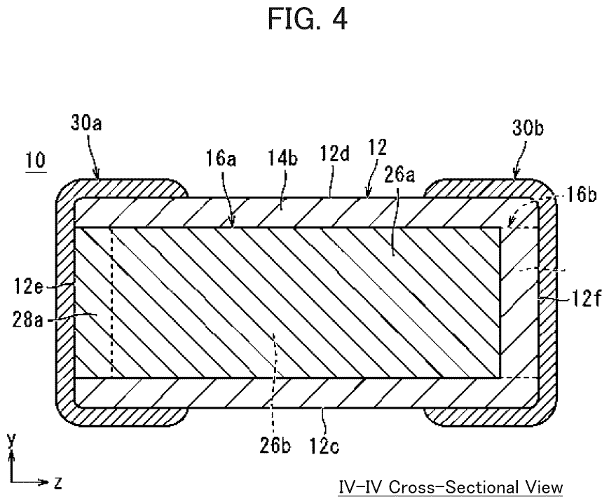

FIG. 1 is an external perspective view of a configuration of a multilayer ceramic capacitor according to an example embodiment of the present invention. FIG. 2 is a cross-sectional view taken along line II-II in FIG. 1 and a front view of the configuration of the multilayer ceramic capacitor according to an example embodiment of the present invention. FIG. 3 is a cross-sectional view taken along line III-III in FIG. 1 and a lateral view of the configuration of the multilayer ceramic capacitor according to an example embodiment of the present invention. FIG. 4 is a top view corresponding to a cross-section taken along line IV-IV in FIG. 2 and shows the configuration of the multilayer ceramic capacitor according to an example embodiment of the present invention.

As shown in FIGS. 1 to 4, the multilayer ceramic capacitor 10 includes a multilayer body 12 and external electrodes 30 disposed on surfaces of the multilayer body 12.

As shown in FIG. 1, the multilayer body 12 included in the multilayer ceramic capacitor 10 has a rectangular or substantially rectangular parallelepiped shape. The “rectangular parallelepiped shape” encompasses a rectangular parallelepiped shape having rounded corner portions and ridge portions. That is, a member having a “rectangular parallelepiped shape” means a member in general including first and second main surfaces 12a and 12b, first and second lateral surfaces 12c and 12d, and first and second end surfaces 12e and 12f.

More specifically, the multilayer body 12 includes the first main surface 12a and the second main surface 12b opposed to each other, the first lateral surface 12c and the second lateral surface 12d opposed to each other while connecting the first main surface 12a and the second main surface 12b, and the first end surface 12e and the second end surface 12f extending in a direction orthogonal to the first lateral surface 12c and the second lateral surface 12d, and opposed to each other while connecting the first main surface 12a and the second main surface 12b.

Corner portions and ridge portions of the multilayer body 12 may be angular or rounded. The corner portions each refer to a portion where three adjacent surfaces of the multilayer body 12 intersect, and the ridge portions each refer to a portion where two adjacent surfaces of the multilayer body 12 intersect.

Some or all of the first and second main surfaces 12a and 12b, the first and second lateral surfaces 12c and 12d, and the first and second end surfaces 12e and 12f may include irregularities such as projections and recesses.

A direction that connects the first main surface 12a and the second main surface 12b of the multilayer body 12 is defined as a height direction x. A direction that is orthogonal or substantially orthogonal to the height direction x, and connects the first lateral surface 12c and the second lateral surface 12d is defined as a width direction y. A direction that is orthogonal or substantially orthogonal to the height direction x and the width direction y, and connects the first end surface 12e and the second end surface 12f is defined as a length direction z. In the following description, a dimension in the length direction z, a dimension in the height direction x, and a dimension in the width direction y with respect to the multilayer ceramic capacitor 10 including the multilayer body 12 and the external electrodes 30 described below are referred to as an L dimension, a T dimension, and a W dimension, respectively. These terms are used in the following description.

In the multilayer body 12, a plurality of dielectric layers 14 and a plurality of internal electrode layers 16 are laminated in the height direction x.

The multilayer body 12 includes an inner layer portion 18 including one or a plurality of dielectric layers 14b and a plurality of internal electrode layers 16 disposed on the dielectric layers 14b. In the inner layer portion 18, the plurality of internal electrode layers 16 are opposed to each other with the dielectric layers 14b therebetween.

The multilayer body 12 includes a first main surface-side outer layer portion 20a that is located on a first main surface 12a side, and that includes a plurality of dielectric layers 14a located between the first main surface 12a, an outermost surface of the inner layer portion 18 on the first main surface 12a side, and a straight line along this outermost surface. The multilayer body 12 also includes a second main surface-side outer layer portion 20b that is located on a second main surface 12b side, and that includes a plurality of dielectric layers 14a located between the second main surface 12b, an outermost surface of the inner layer portion 18 on the second main surface 12b side, and a straight line along this outermost surface.

The multilayer body 12 includes a first lateral surface-side outer layer portion 22a that is located on a first lateral surface 12c side, and that includes a plurality of dielectric layers 14b located between the first lateral surface 12c and an outermost surface of the inner layer portion 18 on the first lateral surface 12c side. The multilayer body 12 also includes a second lateral surface-side outer layer portion 22b that is located on a second lateral surface 12d side, and that includes a plurality of dielectric layers 14b located between the second lateral surface 12d and an outermost surface of the inner layer portion 18 on the second lateral surface 12d side.

The multilayer body 12 includes a first end surface-side outer layer portion 24a that is located on a first end surface 12e side, and that includes a plurality of dielectric layers 14b located between the first end surface 12e and an outermost surface of the inner layer portion 18 on the first end surface 12e side. The multilayer body 12 also includes a second end surface-side outer layer portion 24b that is located on a second end surface 12f side, and that includes a plurality of dielectric layers 14b located between the second end surface 12f and an outermost surface of the inner layer portion 18 on the second end surface 12f side. No particular limitations are provided for the dimensions of the multilayer body 12.

Examples of materials for forming the dielectric layers 14 include a ceramic material as a dielectric material. Examples of usable dielectric materials include a dielectric ceramic including BaTiO₃, CaTio₃, SrTiO₃, or CaZro₃ as a main component.

In addition to the main component, the material for forming the dielectric layers 14 may include a subcomponent in a smaller amount than the main component depending on desired properties of the multilayer body 12. Examples of subcomponents include a Mn compound, an Fe compound, a Cr compound, a Co compound, or a Ni compound. Furthermore, the material for forming the dielectric layers 14 may include either or both of Si and Mn in elemental form added as a subcomponent.

In particular, the material for forming the dielectric layers 14 preferably includes, for example, as the ceramic material, at least one of Ca, Sr, Ba, or Zr. Selecting these materials provides the advantage of ensuring good temperature characteristics.

The ceramic material for forming the dielectric layers 14 have an average particle diameter of, for example, about 710 nm or greater and about 830 nm or less.

If the average particle diameter of the ceramic material is less than about 710 nm, which in other words is if sintering is insufficient, solid solution formation of acceptors such as Mn does not progress, leading to unfavorable heat generation characteristics, which in other words is a high tendency for heat generation. On the other hand, if the average particle diameter of the ceramic material is greater than about 830 nm, the dielectric layers 14 include fewer particles and the voltage to be applied per particle is higher, also leading to unfavorable heat generation characteristics.

The average particle diameter of the dielectric layers 14 is, for example, measured as described below. First, the multilayer body 12 is polished in the width direction y up to a position that is about ½ of the W dimension so that an LT cross-section is exposed. Using a scanning electron microscope, imaging and observation are performed at a magnification of approximately 10000× on an area around an end of a first extension electrode portion 28a of a first internal electrode layer 16a or a second extension electrode portion 28b of a second internal electrode layer 16b, which are described below, located in a position that is about ½ of the dimension of the multilayer body 12 in the T direction on the surface exposed by polishing. Using image processing software, equivalent a circular diameters of predetermined number of ceramic particles present on a plane of the image obtained as described above are calculated, and the average value thereof is determined as the average particle diameter. Preferably, the predetermined number of ceramic particles on the plane of the image is, for example, 60 or more.

In order to obtain a more accurate average value, the above-described measurement is repeated by performing the measurement on three different multilayer bodies 12 to obtain three average particle diameters, and the average of the three average particle diameters is determined as the final average particle diameter.

Preferably, the dielectric layers 14 in the multilayer body 12 that has gone through the firing have a thickness of, for example, about 1 μm or more and about 20 μm or less.

The average thickness of the dielectric layers 14 is, for example, measured as described below. First, the multilayer body 12 is polished in the width direction y up to a position that is about ½ of the W dimension so that an LT cross-section is exposed. Thicknesses of dielectric layers 14 on five lines in total, which include a center line of the dielectric layers 14 that extends in the lamination direction and passes through the center of the LT cross-section exposed by polishing, and two equally spaced pairs of reference lines that each extend from the aforementioned center line in the length direction z on either side, are measured, and the average value of the measured thicknesses is determined as the average thickness of the dielectric layers 14.

In order to obtain a more accurate average thickness, the above-described measurement is repeated by performing the measurement on three regions of the LT cross-section, i.e., an upper region, a central region, and a lower region in the lamination direction, and five thicknesses are measured for each of the three regions. Then, the average value of all the measured thicknesses is determined as the average thickness.

Preferably, for example, 10 or more and 800 or less dielectric layers 14 are laminated. The number of dielectric layers 14 herein means the total number of dielectric layers 14 including the number of dielectric layers 14 forming the inner layer portion 18, and the number of dielectric layers forming the first main surface-side outer layer portion 20a and the second main surface-side outer layer portion 20b.

The multilayer body 12 includes, for example, a plurality of first internal electrode layers 16a and a plurality of second internal electrode layers 16b that have a rectangular or substantially rectangular shape as the plurality of internal electrode layers 16. The first internal electrode layers 16a and the second internal electrode layers 16b are embedded and alternately arranged at equal or substantially equal intervals in the height direction x of the multilayer body 12 with the dielectric layers 14 therebetween. Each of the first internal electrode layers 16a and the second internal electrode layers 16b is parallel or substantially parallel to the first main surface 12a and the second main surface 12b. The first internal electrode layers 16a and the second internal electrode layers 16b are opposed to each other in the height direction x with the dielectric layers 14 therebetween.

For ease of explanation, the drawings each show a multilayer body including six first internal electrode layers 16a arranged from top to bottom in the height direction x as the plurality of first internal electrode layers 16a and six second internal electrode layers 16b arranged from top to bottom in the height direction x as the plurality of second internal electrode layers 16b. However, this configuration is merely an example, and the multilayer body 12 may include any number of first and second internal electrode layers 16a and 16b such as another example given below.

The first internal electrode layers 16a and the second internal electrode layers 16b are respectively disposed on the dielectric layers 14 and located inside the multilayer body 12.

The first internal electrode layers 16a are disposed on the plurality of dielectric layers 14 and located inside the multilayer body 12. Each of the first internal electrode layers 16a includes a first counter electrode portion 26a opposed to adjacent second internal electrode layers 16b, and a first extension electrode portion 28a that is located at one end of the first internal electrode layer 16a and extends from the first counter electrode portion 26a to the first end surface 12e of the multilayer body 12. An end of the first extension electrode portion 28a is located on the outer side of the first end surface 12e and exposed from the multilayer body 12. As such, each first internal electrode layer 16a is not exposed at the first main surface 12a, the second main surface 12b, the first lateral surface 12c, the second lateral surface 12d, or the second end surface 12f. In other words, an end of each first internal electrode layer 16a opposite to the exposed end is slightly spaced inward from the second end surface 12f.

The shape of the first counter electrode portion 26a of each first internal electrode layer 16a is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The shape of the first extension electrode portion 28a of each first internal electrode layer 16a is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The first counter electrode portion 26a of each first internal electrode layer 16a and the first extension electrode portion 28a of each first internal electrode layer 16a may have the same or substantially the same width, or either one may have a narrower width.

The second internal electrode layers 16b are disposed on the dielectric layers 14 and located inside the multilayer body 12. Each of the second internal electrode layers 16b includes a second counter electrode portion 26b opposed to adjacent first internal electrode layers 16a, and a second extension electrode portion 28b that is located at one end of the second internal electrode layer 16b and extends from the second counter electrode portion 26b to the second end surface 12f of the multilayer body 12. An end of the second extension electrode portion 28b is located on the outer side of the second end surface 12f and exposed from the multilayer body 12. As such, each second internal electrode layer 16b is not exposed at the first main surface 12a, the second main surface 12b, the first lateral surface 12c, the second lateral surface 12d, or the first end surface 12e. In other words, an end of each second internal electrode layer 16b opposite to the exposed end is slightly spaced inward from the first end surface 12e.

The shape of the second counter electrode portion 26b of each second internal electrode layer 16b is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The shape of the second extension electrode portion 28b of each second internal electrode layer 16b is not particularly limited, but is preferably rectangular or substantially rectangular in a plan view. However, corner portions thereof may be rounded in a plan view or sloped (tapered) in a plan view. Furthermore, the corner portions may each be tapered in a plan view with a slope toward one direction.

The second counter electrode portion 26b of each second internal electrode layer 16b and the second extension electrode portion 28b of each second internal electrode layer 16b may have the same or substantially the same width, or either one may have a narrower width.

In the present example embodiment, the percent coverage of the dielectric layers 14 by the first internal electrode layers 16a and the percent coverage of the dielectric layers 14 by the second internal electrode layers 16b are, for example, about 60% or higher and about 85% or lower. The percent coverage is calculated in accordance with the following equation based on the length of the internal electrode layers 16 in the length direction z (internal electrode layer length) and the length of the dielectric layers 14 covered by the internal electrode layers 16: percent coverage=internal electrode layer length/dielectric layer length×100.

If the percent coverage by the internal electrode layers 16 is lower than about 60%, the dielectric layers 14 lack smoothness, leading to unfavorable heat generation characteristics. On the other hand, if the percent coverage by the internal electrode layers 16 is higher than about 85%, stress is generated at the interfaces between the internal electrode layers 16 and the dielectric layers 14 to cause dielectric alignment, leading to unfavorable heat generation characteristics.

Actual measurement of the value of the percent coverage is, for example, performed as described below. First, the multilayer body 12 is polished in the width direction y up to a position that is about ½ of the W dimension so that an LT cross-section is exposed. In this process, care should be taken to prevent the internal electrode layers 16 and the dielectric layers 14 from being broken by polishing.

Next, through a bright field microscopy using a metallographic microscope, imaging and observation are performed at a magnification of approximately 50× on an area around an end of a first extension electrode portion 28a of a first internal electrode layer 16a or a second extension electrode portion 28b of a second internal electrode layer 16b located in a position that is about ½ of the T dimension of the multilayer body 12 in the height direction x on the surface exposed by polishing. With respect to each of the first internal electrode layers 16a or the second internal electrode layers 16b present on a plane of the image obtained as described above, a ratio of the length of the internal electrode layer 16 to the corresponding dielectric layer 14 is calculated as the percent coverage, and the average value of the calculated ratios is determined as the percent coverage by the internal electrode layers 16 in the multilayer body 12.

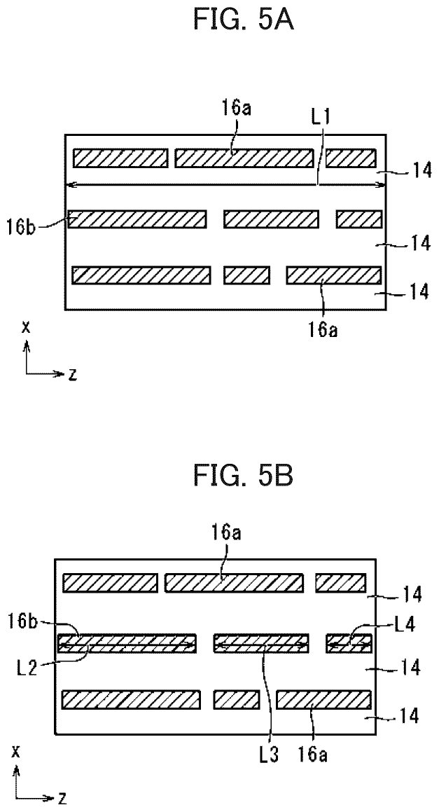

Specifically, as shown in FIG. 5A, a length of a dielectric layer 14 in the length direction z in a region of a first extension electrode portion 28a adjacent to the first end surface 12e or a region of a second extension electrode portion 28b adjacent to the second end surface 12f in the image obtained using the metallographic microscope is measured as a dielectric layer length (L1). As shown in FIG. 5B, lengths (L2, L3, and L4) of an internal electrode layer 16 in the length direction z in the region of the first extension electrode portion 28a adjacent to the first end surface 12e or the region of the second extension electrode portion 28b adjacent to the second end surface 12f in the image obtained using the metallographic microscope are measured, and the sum of the measured lengths is determined as the length of the internal electrode layer 16. Then, based on the measured length (L1) of the dielectric layer 14 and the length (L2+L3+L4) of the internal electrode layer 16, the percent coverage is calculated in accordance with the following equation. Percent coverage=internal electrode layer length (L2+L3+L4)/dielectric layer length (L1)×100

Preferably, percent coverages of 10 or more selected first and second internal electrode layers 16a and 16b are calculated, and then the average value of the calculated percent coverages is determined as the percent coverage in a single multilayer body.

In order to obtain a more accurate average value, the above-described measurement is repeated by performing the measurement on three different multilayer bodies 12 to obtain three average percent coverages, and the average of the three average percent coverages is determined as the final percent coverage of the internal electrode layers 16.

Furthermore, in the multilayer ceramic capacitor 10, the ratio of the thickness of the dielectric layers 14 to the thickness of the internal electrode layers 16 (thickness of dielectric layer 14/thickness of internal electrode layer 16) is preferably greater than 1. In this case, it is possible to reduce the amount of height difference in the lateral surface-side outer layer portions 22a and 22b, and the end surface-side outer layer portions 24a and 24b that results from the thickness of the internal electrode layers 16 when dielectric sheets (green sheets) are laminated, preventing occurrence of a structural defect such as delamination.

The first internal electrode layers 16a and the second internal electrode layers 16b of the internal electrode layers 16 may be, for example, made of an electrically conductive material selected as appropriate from the group of metals such as Ni, Cu, Ag, Pd, and Au, and alloys including at least one of these metals such as a Ag—Pd alloy. In a configuration in which base electrode layers of the external electrodes 30 described below include electrically conductive resin layers, the metal of the internal electrode layers 16 and a metal of an electrically conductive filler included in the electrically conductive resin layers form a compound.

The thickness of each of the first internal electrode layers 16a and the second internal electrode layers 16b is not particularly limited, but is preferably, for example, about 0.1 μm or more and about 3.0 μm or less.

The average thickness of the first internal electrode layers 16a or the second internal electrode layers 16b is, for example, measured as described below. First, the multilayer body 12 is polished in the width direction y up to a position that is about ½ of the W dimension so that an LT cross-section is exposed. Thicknesses of first internal electrode layers 16a or second internal electrode layers 16b on five lines in total, which include a center line of the first internal electrode layers 16a or the second internal electrode layers 16b that extends in the lamination direction and passes through the center of the LT cross-section exposed by polishing, and two equally spaced pairs of reference lines that each extend from the aforementioned center line in the length direction z on either side, are measured, and the average value of the measured thicknesses is determined as the average thickness of the first internal electrode layers 16a or the second internal electrode layers 16b.

In order to obtain a more accurate average thickness, the above-described measurement is repeated by performing the measurement on three regions of the LT cross-section, i.e., an upper region, a central region, and a lower region in the lamination direction, and five thicknesses are measured for each of the three regions. Then, the average value of all of the measured thicknesses is determined as the average thickness.

The number of first internal electrode layers 16a and the number of second internal electrode layers 16b are not particularly limited, but are, for example, each preferably 10 or more and 800 or less.

As shown in FIGS. 1 to 4, the external electrodes 30 are disposed on the first end surface 12e and the second end surface 12f of the multilayer body 12.

The external electrodes 30 include a first external electrode 30a and a second external electrode 30b.

The first external electrode 30a is electrically connected to the first internal electrode layers 16a and is provided on the outer side of the first end surface 12e. The first external electrode 30a extends along the multilayer body 12 from the first end surface 12e of the multilayer body 12 to be provided also on a portion of the first main surface 12a and a portion of the second main surface 12b, and a portion of the first lateral surface 12c and a portion of the second lateral surface 12d.

The second external electrode 30b is electrically connected to the second internal electrode layers 16b and is provided on the outer side of the second end surface 12f. The second external electrode 30b extends along the multilayer body 12 from the second end surface 12f of the multilayer body 12 to be provided also on a portion of the first main surface 12a and a portion of the second main surface 12b, and a portion of the first lateral surface 12c and a portion of the second lateral surface 12d.

In the multilayer body 12, the first counter electrode portions 26a of the first internal electrode layers 16a and the second counter electrode portions 26b of the second internal electrode layers 16b are opposed to each other with the dielectric layers 14 therebetween to generate capacitance. Capacitance can therefore be obtained between the first external electrode 30a connected to the first internal electrode layers 16a and the second external electrode 30b connected to the second internal electrode layers 16b, resulting in capacitor characteristics.

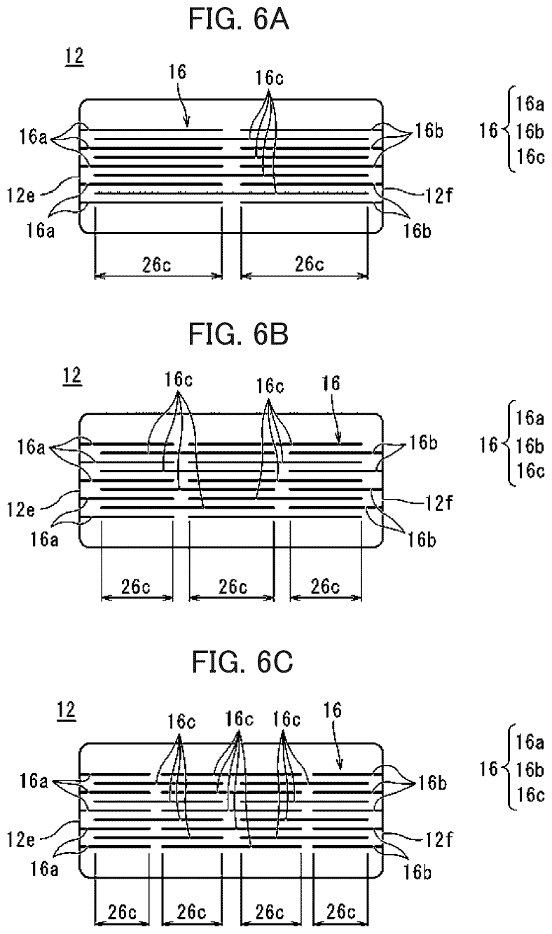

The multilayer body 12 shown in FIG. 1 may have a structure such as shown in FIGS. 6A to 6C, which includes floating internal electrode layers 16c that do not extend to the first end surface 12e or the second end surface 12f, in addition to the first internal electrode layers 16a and the second internal electrode layers 16b, and which include a plurality of separate counter electrode portions 26c based on the floating internal electrode layers 16c. For example, the multilayer body 12 may have a two-portion structure shown in FIG. 6A, a three-portion structure shown in FIG. 6B, or a four-portion structure shown in FIG. 6C. The multilayer body 12 may also have a more than four-portion structure. As a result of the multilayer body 12 having a structure including the plurality of separate counter electrode portions 26c, a plurality of capacitor components are provided between the internal electrode layers 16a, 16b, and 16c opposed to each other, providing a configuration in which these capacitor components are connected in series. This configuration allows the voltage that is applied to each capacitor component to be lower, helping achieve higher voltage resistance of the multilayer ceramic capacitor 10.

Preferably, for example, each external electrode 30 has an internal configuration including a base electrode layer 32 including a metal component and a glass component, and a plated layer 34 disposed on a surface of the base electrode layer 32.

The base electrode layers 32 include a first base electrode layer 32a in the first external electrode 30a and a second base electrode layer 32b in the second external electrode 30b.

The first base electrode layer 32a is provided on the outer side of the first end surface 12e of the multilayer body 12, and extends from the first end surface 12e so as to cover a portion of the first main surface 12a and a portion of the second main surface 12b, and a portion of the first lateral surface 12c and a portion of the second lateral surface 12d.

The second base electrode layer 32b is provided on the outer side of the second end surface 12f of the multilayer body 12, and extends from the second end surface 12f so as to cover a portion of the first main surface 12a and a portion of the second main surface 12b, and a portion of the first lateral surface 12c and a portion of the second lateral surface 12d.

The first base electrode layer 32a may be provided only on the outer side of the first end surface 12e of the multilayer body 12, and the second base electrode layer 32b may be provided only on the outer side of the second end surface 12f of the multilayer body 12.

Preferably, each base electrode layer 32 includes at least one of a baked layer, an electrically conductive resin layer, or a thin film layer. The following describes baked layers that are defined by the base electrode layers.

The baked layers are obtained by applying an electrically conductive paste including a glass component and a metal onto the multilayer body 12 and baking the electrically conductive paste. The glass component of the baked layers includes, for example, at least one of B, Si, Ba, Zn, Mg, Al, or Li. The metal of the baked layers includes, for example, at least one of Cu, Ni, Ag, Pd, a Ag—Pd alloy, or Au.

The baked layers may be formed by simultaneously firing a multilayer chip having the internal electrode layers 16 and the dielectric layers 14, from which the multilayer body 12 is formed, and the electrically conductive paste applied onto the multilayer chip. Alternatively, the baked layers may be formed by baking the electrically conductive paste applied onto the multilayer body 12 after the multilayer body 12 has been formed by firing the multilayer chip. In a case where the multilayer chip and the electrically conductive paste applied onto the multilayer chip are simultaneously fired, the baked layers preferably include a dielectric material instead of the glass component. Each baked layer may include a single layer or a plurality of layers.

In a configuration in which baked layers include the first base electrode layer 32a and the second base electrode layer 32b, preferably, a central portion of the first base electrode layer 32a and a central portion of the second base electrode layer 32b in the height direction x have, for example, a thickness of about 10 μm or more and about 150 μm or less in the length direction z.

The following describes electrically conductive resin layers that are provided as the base electrode layers. In a configuration in which electrically conductive resin layers are provided as the base electrode layers, the electrically conductive resin layers may be disposed directly on the multilayer body 12 or may be disposed so as to cover the baked layers or other material layers already provided as portion of the base electrode layers.

In the latter case, the electrically conductive resin layers may cover the baked layers or other material layers completely or partially. Specifically, each of the electrically conductive resin layers provided as the first base electrode layer 32a and the second base electrode layer 32b is preferably provided to cover the corresponding one of the first end surface 12e and the second end surface 12f, and extend to cover a portion of the first main surface 12a and a portion of the second main surface 12b, and a portion of the first lateral surface 12c and a portion of the second lateral surface 12d. Alternatively, each of the electrically conductive resin layers formed as the first base electrode layer 32a and the second base electrode layer 32b may be provided to only cover the corresponding one of the first end surface 12e and the second end surface 12f.

Furthermore, the electrically conductive resin layers preferably have, for example, a thickness of about 10 μm or more and about 200 μm or less.

The electrically conductive resin layers are, for example, made of a material including a thermosetting resin and a metal component such as electrically conductive particles. As a result of including a thermosetting resin, the electrically conductive resin layers are more flexible than, for example, electrically conductive layers made of a plated film or a fired electrically conductive paste. The electrically conductive resin layers can therefore define and function as buffer layers to prevent formation of cracks in the multilayer ceramic capacitor 10 even if the multilayer ceramic capacitor 10 is subjected to a physical shock or a shock resulting from thermal cycling.

Preferably, the electrically conductive resin layers each include a metal in an amount of about 35 vol % or more and about 75 vol % or less relative to the total volume of the electrically conductive resin.

The metal included in the form of electrically conductive particles in the electrically conductive resin layers is mainly responsible for the electrical conductivity of the electrically conductive resin layers. Specifically, particles of the electrically conductive filler make contact with each other to provide electrical paths inside the electrically conductive resin layers.

Examples of metals that can be included in the form of electrically conductive particles in the electrically conductive resin layers include Ag, Cu, or an alloy including some or both of these metals.

Furthermore, metal particles each including a Ag-coated surface are also usable as the electrically conductive particles. In this case, preferably, Cu or Ni is used as the metal. An Ag-coated metal is used for the electrically conductive particles because Ag has the lowest specific resistance among metals, and thus is suitable for electrode materials. Furthermore, Ag, which is a noble metal, does not oxidize and has higher weatherability. Furthermore, the use of a Ag-coated metal provides a choice for an inexpensive base material metal while maintaining the properties of Ag.

Antioxidant treated Cu, for example, is also usable as the metal contained in the electrically conductive resin layers.

No particular limitations are placed on the particle shape of the metal included in the electrically conductive resin layers. For example, a metal having a spherical or flat particle shape is usable. In the present example embodiment, in particular, spherical metal powder and flat metal powder are preferably used in combination. The electrically conductive filler may have, for example, a spherical or flat particle shape. No particular limitations are placed on the average particle diameter of the metal included in the electrically conductive resin layers. For example, the electrically conductive filler may have an average particle diameter of about 0.3 μm or more and about 10 μm or less.

Examples of resins suitable for the electrically conductive resin layers include various known thermosetting resins such as epoxy resins, phenol resins, urethane resins, silicone resins, and polyimide resins. In particular, epoxy resins, which have excellent heat resistance, moisture resistance, and adhesion, are one of the more suitable resins.

Preferably, the electrically conductive resin layers include a curing agent along with the thermosetting resin. The electrically conductive resin layers may include, for example, an epoxy resin as the thermosetting resin, which is a base resin. Examples of curing agents usable for the epoxy resin include various known compounds such as phenol compounds, amine compounds, anhydride compounds, imidazole compounds, active ester compounds, and amide-imide compounds.

Each electrically conductive resin layer may include a single layer or a plurality of layers.

The following describes thin film layers that are provided as the base electrode layers. In a configuration in which thin film layers are provided as the base electrode layers, the thin film layers include deposited metal particles and have an average thickness of, for example, about 1 μm or less. The thin film layers are formed by a thin film formation method such as sputtering or vapor deposition, for example.

The plated layers 34 include a first plated layer 34a in the first external electrode 30 and a second plated layer 34b in the second external electrode 30b. As shown in FIGS. 2 to 4, in particular, the plated layers cover the entire or substantially the entire surfaces of the respective base electrode layers so that the base electrode layers are not exposed to the outside. Specifically, the first plated layer 34a is preferably provided to cover a portion of the first base electrode layer 32a located on top of the first end surface 12e, and extend to cover portions of the first base electrode layer 32a located on top of the first main surface 12a and the second main surface 12b, and the first lateral surface 12c and the second lateral surface 12d. The second plated layer 34b is preferably provided to cover a portion of the second base electrode layer 32b located on top of the second end surface 12f, and extend to cover portions of the second base electrode layer 32b located on top of the first main surface 12a and the second main surface 12b, and the first lateral surface 12c and the second lateral surface 12d. Alternatively, the first plated layer 34a may be provided to only cover the portion of the first base electrode layer 32a located on top of the first end surface 12e, and the second plated layer 34b may be provided to only cover the portion of the second base electrode layer 32b located on top of the second end surface 12f.

No particular limitations are placed on the plated layers 34 as long as the plated layers 34 include, for example, at least one metal selected from Cu, Ni, Sn, Ag, Pd, a Ag—Pd alloy, or Au.

Each plated layer 34 may include a single layer or a plurality of layers. In the latter case, for example, each plated layer 34 preferably has a two-layer structure including a Ni plated layer and a Sn plated layer. As a result of including the Ni plated layers as layers disposed in direct contact with the base electrode layers, the plated layers 34 can prevent the base electrode layers from being corroded by solder that is used when the multilayer ceramic capacitor 10 is mounted particularly in a case where the electrically conductive resin layers are formed as the base electrode layers.

Furthermore, as a result of including the Sn plated layers as upper layers of the Ni plated layers, the plated layers 34 can improve the wettability of solder that is used when the multilayer ceramic capacitor 10 is mounted, facilitating the mounting.

In the case of the plated layers 34 each having a two-layer structure of a Ni plated layer and a Sn plated layer, preferably, the thickness per layer is about 1 μm or more and about 15 μm or less, for example.

A dimension of the multilayer ceramic capacitor 10 including the multilayer body 12, the first external electrode 30a, and the second external electrode 30b in the length direction z is referred to as an L dimension. A dimension of the multilayer ceramic capacitor 10 including the multilayer body 12, the first external electrode 30a, and the second external electrode 30b in the height direction x is referred to as a T dimension. A dimension of the multilayer ceramic capacitor 10 including the multilayer body 12, the first external electrode 30a, and the second external electrode 30b in the width direction y is referred to as a W dimension. For example, the multilayer ceramic capacitor 10 has an L dimension in the length direction z of about 10.0 mm or more and about 60.0 mm or less, a W dimension in the width direction y of about 0.1 mm or more and about 60.0 mm or less, and a T dimension in the height direction x of about 0.1 mm or more and about 10.0 mm or less. The dimensions of the multilayer ceramic capacitor 10 can be measured using a microscope.

In the multilayer ceramic capacitor 10 having a configuration such as described above, the ceramic particles in the ceramic material forming the dielectric layers 14 have an average particle diameter of, for example, about 710 nm or greater and about 830 nm or less. This configuration makes it possible to both promote solid solution formation of acceptors and optimize the number of particles in the dielectric layers 14, thus enabling a reduction in the occurrence of the high-frequency heat generation. Thus, the multilayer ceramic capacitor 10 enable a reduction in the occurrence of the high-frequency heat generation. That is, due to the configuration in which the particle diameter of the ceramic material is controlled as described above, the solid solution formation is promoted and the number of particles is appropriately adjusted in the dielectric layers 14, and thus the multilayer ceramic capacitor 10 produces the advantageous effect of reducing the occurrence of the high-frequency heat generation in the multilayer body 12.

The multilayer ceramic capacitor 10 is also characterized in that the percent coverage of the dielectric layers 14 by the internal electrode layers 16 is, for example, about 60% or higher and about 85% or lower. This characteristic helps reduce the occurrence of the high-frequency heat generation. That is, due to the configuration in which the percent coverage is controlled as described above, smoothing of the dielectric layers 14 in the multilayer body 12 and mitigation of stress within the dielectric layers 14 that is generated at the interfaces between the internal electrode layers 16 and the dielectric layers 14 are achieved in a balanced manner, and thus the multilayer ceramic capacitor 10 produces the advantageous effect of reducing the occurrence of the high-frequency heat generation in the multilayer body 12.

As described above, due to the configuration in which the average particle diameter of the ceramic particles in the ceramic material of the dielectric layers 14 is about 710 nm or greater and about 830 nm or less, and the percent coverage of the dielectric layers 14 by the internal electrode layers 16 is about 60% or higher and about 85% or lower, the multilayer ceramic capacitor 10 according to the present example embodiment of the present invention allows for a reduction in occurrence of the high-frequency heat generation.

### 2. Multilayer Ceramic Capacitor Manufacturing Method

The following describes an example of a method for manufacturing a multilayer ceramic capacitor according to an example embodiment of the present invention.

### Preparation

First, dielectric sheets for forming dielectric layers and an electrically conductive paste for forming internal electrode layers that define and function as the first internal electrode layers and the second internal electrode layers are prepared. The dielectric sheets to be prepared include those on which the first internal electrode layers are provided, those on which the second internal electrode layers are provided, and those on which no internal electrode layer is provided. The dielectric sheets and the electrically conductive paste each include a binder and a solvent. The dielectric sheets and the electrically conductive paste may include a known binder and a known solvent.

### Multilayer Sheet Production

Next, the electrically conductive paste for forming internal electrode layers is printed on dielectric sheets in predetermined patterns by, for example, screen printing or gravure printing. As a result, dielectric sheets including a first internal electrode layer pattern and dielectric sheets including a second internal electrode layer pattern are prepared.

Dielectric sheets including no internal electrode layer pattern printed thereon are also prepared for forming outer layers. Subsequently, a predetermined number of dielectric sheets including no internal electrode layer pattern printed thereon for forming outer layers are laminated to form a laminate that defines and functions as the second main surface-side outer layer portion. On top of the laminate that defines and functions as the second main surface-side outer layer portion, the dielectric sheets including the first internal electrode layer pattern printed thereon and the dielectric sheets including the second internal electrode layer pattern printed thereon are sequentially laminated so as to give the structure of the present invention. As a result, a laminate that defines and functions as the inner layer portion is formed. On top of the laminate that defines and functions as the inner layer portion, a predetermined number of dielectric sheets including no internal electrode layer pattern printed thereon for forming outer layers are laminated to form a laminate that defines and functions as the first main surface-side outer layer portion.

### Multilayer Block Production

Next, the resulting multilayer sheet is pressed in the lamination direction of the dielectric sheets by, for example, a hydrostatic press or other method to produce a multilayer block.

### Multilayer Chip Production

A plurality of multilayer chips are cut out from the multilayer block by cutting the multilayer block into a predetermined size. In this step, corner portions and ridge portions of each multilayer chip may be rounded by barrel polishing or other method.

### Multilayer Body Production

Each multilayer chip is fired to produce a multilayer body. A batch furnace is used for the firing. Preferably, the difference in temperature between the uppermost level and the lowermost level in the batch furnace is, for example, no greater than about +10° C. Preferably, the maximum temperature in the firing furnace is, for example, in a range of from about 1300° C. to about 1400° C., and the maximum temperature holding time is in a range of, for example, from about 1 hour to about 5 hours. As long as these conditions for the firing of the multilayer chips are satisfied, it is possible to achieve the configuration described above in which the average particle diameter of the ceramic material forming the dielectric layers is about 710 nm or greater and about 830 nm or less, and the percent coverage of the dielectric layers by the internal electrode layers is about 60% or higher and about 85% or lower.

### External Electrode Formation

### (a) Configuration Having Baked Layers

The following describes formation of baked layers as the base electrode layers. Baked layers are formed as the base electrode layers by preparing, applying, and then baking an electrically conductive paste containing a glass component and a metal.

The first base electrode layer of the first external electrode and the second base electrode layer of the second external electrode are formed on the first end surface and the second end surface of the multilayer body.

The baked layers are, for example, formed by an application method such as dipping or screen printing. The electrically conductive paste is applied onto the first end surface and the second end surface of the multilayer body, and then baked. The baking temperature is, for example, preferably about 700° C. or higher and about 900° C. or lower.

### (b) Configuration Having Electrically Conductive Resin Layers

In a configuration in which electrically conductive resin layers are formed as the first base electrode layer and the second base electrode layer, the following method can be employed. The electrically conductive resin layers may be formed on surfaces of the baked layers, or may be formed directly on the multilayer body without forming the baked layers therebetween.

The electrically conductive resin layers are formed by applying an electrically conductive resin paste including a thermosetting resin and a metal component onto the baked layers or the multilayer body, and thermally curing the resin through heat treatment at a temperature of, for example, about 250° C. or higher and about 550° C. or lower. Preferably, for example, the heat treatment is performed under a N₂ atmosphere. Preferably, for example, the oxygen concentration is maintained at about 100 ppm or lower to prevent scattering of the resin and oxidation of any metal component.

The electrically conductive resin paste can be, for example, applied by using a method involving extruding the electrically conductive resin paste through a slit or a roller transfer method, which can be also employed for forming the baked layers as the base electrode layers.

### (c) Configuration Including Thin Film Layers

In a configuration in which thin film layers are, for example, formed as the first base electrode layer and the second base electrode layer, the thin film layers are formed by masking or otherwise covering areas other than desired areas where the external electrodes are to be formed, and performing sputtering, vapor deposition, or other thin film formation method on the desired areas thus exposed.

### Plated Layer Formation

Lastly, the first plated layer and the second plated layer are formed. The plated layers may be respectively formed on surfaces of the first base electrode layer and the second base electrode layer, or may be formed directly on the multilayer body.

In the present example embodiment, the plated layers are respectively formed on the surfaces of the first base electrode layer and the second base electrode layer. More specifically, for example, Ni plated layers are formed as first and second plated layers on the first and second base electrode layers, and Sn plated layers are formed on surfaces of Ni plated layers. Each plated layer is formed through plating according to a barrel plating method. Through the processes described above, the multilayer ceramic capacitor according to the foregoing example embodiment of the present invention is obtained.

### 3. Experimental Example

Examples and Comparative Examples of the multilayer ceramic capacitor were produced as samples in accordance with the manufacturing method described above, and a high-frequency heat generation test was conducted.

### (a) Specifications of Samples According to Examples and Comparative Examples

Multilayer ceramic capacitors with the following specifications were prepared as Examples 1 to 6 and Comparative Examples 1 to 7. The specifications of the multilayer ceramic capacitors prepared are shown below.
Dimensions of multilayer ceramic capacitor (design values): L×W×T=about 3.4 mm×about 2.7 mm×about 2.7 mm
Material of main component of dielectric layers: SrBaZrO₃
Capacitance: about 12.3 nF
Rated voltage: about 1000 V
Electrode material of internal electrode layers: Ni
Structure of external electrodes
(i) First base electrode layer and second base electrode layer: baked layers (containing electrically conductive metal (Cu) and glass component)
Film thickness of central part (central part in height direction x and width direction y) on each of first and second end surfaces: approximately 130 μm
(ii) First plated layer and second plated layer: two-layer structure including Ni plated layer (lower layer) and Sn plated layer (upper layer)
Thickness of Ni plated layer: approximately 2.5 μm
Thickness of Sn plated layer: approximately 4 μm

The average particle diameter of the ceramic particles in the ceramic material and the percent coverage of the dielectric layers by the internal electrode layers were varied among the samples according to Examples 1 to 6 and Comparative Examples 1 to 7.

### (b) High-Frequency Heat Generation Test

The high-frequency heat generation test was conducted by a method described below. First, the samples according to Examples 1 to 6 and Comparative Examples 1 to 7 were each mounted on an environmental substrate having a thickness of about 1.6 mm, and three copper lead wires having a length of about 3 cm were bundled and connected to the positive electrode and the negative electrode. Any number of lead wires may be used as long as heat dissipation can be guaranteed to a certain extent. Hereinafter, the thus obtained assemblies are referred to as test samples.

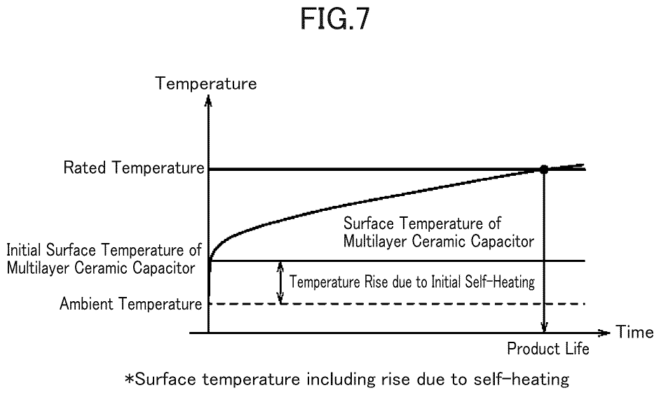

Each test sample was placed in a thermostatic chamber at about 65° C., and a voltage of about 1000 Vp-p and about 100 kHz was applied using an AC power supply, whereupon the surface temperature of the multilayer body in the test sample was measured using a thermocouple. As shown in FIG. 7, which shows an example of heat generation characteristics of a sample multilayer ceramic capacitor, immediately after the start of the test, the surface temperature of the multilayer body rises sharply until the surface temperature reaches thermal equilibrium with the ambient temperature of the multilayer body (the temperature at this point is referred to as an initial surface temperature) due to self-heating of the multilayer ceramic capacitor. Thereafter, the surface temperature of the multilayer body rises gradually as the multilayer body deteriorates. The time it takes for the surface temperature of the multilayer body to reach the rated temperature is the product life of the test sample.

Based on the conditions and the knowledge described above, the high-frequency heat generation characteristics of each test sample were determined and evaluated according to the magnitude of temperature change AT, which is the difference between surface temperatures of the multilayer body measured 1 hour and 10 hours after the start of the test. The test samples were evaluated in accordance with the following criteria.
Good (indicated by circle symbol (∘)): temperature change ΔT was no greater than about 4.5° C.
Poor (indicated by cross symbol (x)): temperature change ΔT was greater than about 4.5° C.

### (c) Results

Table 1 shows the evaluation results as well as the measurement results of the temperature change in the high-frequency heat generation test for the samples according to Examples 1 to 6 and Comparative Examples 1 to 7.

TABLE 1

| | Average | | | |
|---|---|---|---|---|
| | Particle | | | |
| | Diameter of | | | |
| | Ceramic | Percent | | Heat |
| | Particles | Coverage | ΔT | Generation |
| | (mm) | (%) | (° C.) | Evaluation |
| Comparative Example 1 | 420 | 78 | 33.42 | x |
| Comparative Example 2 | 508 | 70 | 5.25 | x |
| Comparative Example 3 | 564 | 73 | 5.73 | x |
| Example 1 | 710 | 78 | 3.84 | ∘ |
| Example 2 | 752 | 78 | 2.73 | ∘ |
| Example 3 | 830 | 78 | 2.46 | ∘ |
| Example 4 | 751 | 60 | 3.21 | ∘ |
| Example 5 | 749 | 85 | 2.43 | ∘ |
| Example 6 | 830 | 60 | 2.76 | ∘ |
| Comparative Example 4 | 738 | 50 | 6.63 | x |
| Comparative Example 5 | 880 | 60 | 7.53 | x |
| Comparative Example 6 | 1020 | 48 | 10.62 | x |
| Comparative Example 7 | 390 | 88 | 31.5 | x |

The results shown in Table 1 indicate that each of the samples according to Comparative Examples 1 to 3 had a temperature change ΔT of greater than about 4.5° C., because the average particle diameter of the ceramic particles in the ceramic material therein was less than about 710 nm although the percent coverage of the dielectric layers by the internal electrode layers therein was within the range of from about 60% to about 85%.

The results also indicate that the sample according to Comparative Example 4 had a temperature change ΔT of greater than about 4.5° C., because the percent coverage of the dielectric layers by the internal electrode layers therein was outside the range of from about 60% to about 85% although the average particle diameter of the ceramic particles in the ceramic material therein was about 738 nm, which falls within the range of from about 710 nm to about 830 nm.

The results further indicate that the sample according to Comparative Example 5 had a temperature change ΔT of greater than about 4.5° C., because the average particle diameter of the ceramic particles in the ceramic material therein was greater than about 830 nm although the percent coverage of the dielectric layers by the internal electrode layers therein was within the range of from about 60% to about 85%.

The results further indicate that each of the samples according to Comparative Examples 6 and 7 had a temperature change ΔT of greater than about 4.5° C., because the average particle diameter of the ceramic particles in the ceramic material therein was outside the range of from about 710 nm to about 830 nm, and the percent coverage of the dielectric layers by the internal electrode layers therein was outside the range of from about 60% to about 85%.

By contrast, each of the samples according to Examples 1 to 6 had a temperature change ΔT of no greater than about 4.5° C., achieving favorable results, because the average particle diameter of the ceramic particles in the ceramic material therein was within the range of from about 710 nm to about 830 nm, and the percent coverage of the dielectric layers by the internal electrode layers therein was within the range of from about 60% to about 85%. These results suggest that the sample multilayer ceramic capacitors according to Examples 1 to 6 each enable a reduction in occurrence of the high-frequency heat generation and offer enhanced long-term reliability, because the average particle diameter of the ceramic particles in the ceramic material therein was within the range of from about 710 nm to about 830 nm, and the percent coverage of the dielectric layers by the internal electrode layers therein was within the range of from about 60% to about 85%.

Although example embodiments of the present invention have been described above, the present invention is not limited thereto.

For example, the multilayer ceramic capacitor 10 according to the above-described example embodiments is described as a two-terminal multilayer ceramic capacitor that has the two external electrodes 30, i.e., the first external electrode 30a and the second external electrode 30b, but may alternatively be a multilayer ceramic capacitor including more than two terminals, such as a three-terminal capacitor. That is to say, the multilayer ceramic capacitor according to example embodiments of the present invention may have any configuration as long as the configuration includes a multilayer body including a plurality of internal electrode layers opposed to each other and arranged with space therebetween, and dielectric layers containing a ceramic material and disposed between the plurality of internal electrode layers. Other specific aspects of the configuration are not limited, such as the number and the shape of the external electrodes and the internal electrode layers connected to the external electrodes.

Various modifications can be made to the above-described example embodiments with regard to configurations, shapes, materials, number and quantities, positions, arrangements, or the like without departing from the scope of the technical idea and the object of the present invention, and these modifications are included in the present invention as well as the above-described example embodiments.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including laminated dielectric layers, a first main surface and a second main surface opposed to each other in a height direction, a first lateral surface and a second lateral surface opposed to each other in a width direction orthogonal or substantially orthogonal to the height direction, and a first end surface and a second end surface opposed to each other in a length direction orthogonal or substantially orthogonal to the height direction and the width direction;
first internal electrode layers alternately laminated with the plurality of dielectric layers and exposed at the first end surface;
second internal electrode layers alternately laminated with the plurality of dielectric layers and exposed at the second end surface;
a first external electrode connected to the first internal electrode layers and provided on the first end surface; and
a second external electrode connected to the second internal electrode layers and provided on the second end surface; wherein
the dielectric layers include a ceramic material;
the ceramic material includes ceramic particles with an average particle diameter of about 710 nm or greater and about 830 nm or less; and
a percent coverage of the dielectric layers by the first internal electrode layers and a percent coverage of the dielectric layers by the second internal electrode layers are about 60% or higher and about 85% or lower.

2. The multilayer ceramic capacitor according to claim 1, wherein the ceramic material includes at least one of Ca, Sr, Ba, or Zr.

3. The multilayer ceramic capacitor according to claim 1, wherein the multilayer body has a rectangular or substantially rectangular parallelepiped shape.

4. The multilayer ceramic capacitor according to claim 3, wherein the multilayer body includes rounded corner portions and rounded ridge portions.

5. The multilayer ceramic capacitor according to claim 1, wherein each of the dielectric layers includes BaTio₃, CaTio₃, SrTiO₃, or CaZrO₃ as a main component.

6. The multilayer ceramic capacitor according to claim 5, wherein each of the dielectric layers includes a Mn compound, an Fe compound, a Cr compound, a Co compound, or a Ni compound as a subcomponent.

7. The multilayer ceramic capacitor according to claim 1, wherein a thickness of each of the dielectric layers is about 1 μm or more and about 20 μm or less.

8. The multilayer ceramic capacitor according to claim 1, wherein a number of the dielectric layers is 10 or more and 800 or less.

9. The multilayer ceramic capacitor according to claim 1, wherein a thickness of each of the first and second internal electrode layers is about 0.1 μm or more and about 3.0 μm or less.

10. The multilayer ceramic capacitor according to claim 1, wherein each of the first and second external electrodes includes a base electrode layer, and a plated layer on the base electrode layer.

11. The multilayer ceramic capacitor according to claim 10, wherein the base electrode layer includes a baked layer including a metal component and a glass component.

12. The multilayer ceramic capacitor according to claim 11, wherein the metal component includes at least one of Cu, Ni, Ag, Pd, a Ag—Pd alloy, or Au.

13. The multilayer ceramic capacitor according to claim 11, wherein the glass component includes at least one of B, Si, Ba, Zn, Mg, Al, or Li.

14. The multilayer ceramic capacitor according to claim 11, wherein a maximum thickness of the baked layer is about 10 μm or more and about 150 μm or less.

15. The multilayer ceramic capacitor according to claim 1, wherein the base electrode layer includes an electrically conductive resin layer.

16. The multilayer ceramic capacitor according to claim 15, wherein a thickness of the electrically conductive resin layer is about 10 μm or more and about 200 μm or less.

17. The multilayer ceramic capacitor according to claim 15, wherein the electrically conductive resin layer includes a thermosetting resin and a metal component.

18. The multilayer ceramic capacitor according to claim 17, wherein the metal component of the electrically conductive resin layer is included in an amount of about 35 vol % or more and about 75 vol or less relative to a total volume of the electrically conductive resin layer.

19. The multilayer ceramic capacitor according to claim 17, wherein the metal component includes Ag, Cu, or an alloy of at least one of Ag or Cu.
